(19) United States
(12) Patent Application Publication
(10) Pub. No.: US 2019/0394361 A1
(43) Pub. Date: Dec. 26, 2019

(54) VIDEO MONITORING METHOD, SERVER, AND VIDEO MONITORING SYSTEM

(71) Applicants: Mitsui Fudosan Co., Ltd, Tokyo (JP); CREW SYSTEMS, INC., Tokyo (JP)

(72) Inventors: Takayasu ISHIDA, Tokyo (JP); Daisuke SATO, Tokyo (JP)

(73) Assignees: Mitsui Fudosan Co., Ltd, Tokyo (JP); CREW SYSTEMS, INC., Tokyo (JP)

(21) Appl. No.: 15/500,696

(22) PCT Filed: Apr. 28, 2016
(86) PCT No.: PCT/JP2016/063383

§ 371 Date: Jan. 31, 2017

(51) Int. Cl. H04N 5/225; H04N 7/18; H04N 21/431; H04N 1/00

(52) U.S. Cl. CPC H04N 5/225; H04N 1/00442; H04N 21/431; H04N 7/18

(57) ABSTRACT

A camera captures and records a moving image. The camera transmits, to a server, still images extracted at first time intervals from the moving image. The server transmits the still images to an administrator terminal. The administrator terminal accepts input for designating the still image. The server transmits an information item for specifying the designated still image to the camera. The camera transmits, to the server, the moving image having a predetermined duration preceding and including the designated still image, or a plurality of the still images extracted at second time intervals each shorter than the predetermined duration from the moving image having the predetermined duration. The server transmits, to the administrator terminal, the moving image having the predetermined duration, or the plurality of the still images extracted at the second time intervals.

### TECHNICAL FIELD

The present invention relates to a video monitoring method, a server, and a video monitoring system.

### BACKGROUND ART

There has been known a system of monitoring a parking lot based on moving images that are transmitted from a camera and displayed on an administrator terminal possessed by an administrator who manages the parking lot.

Japanese Patent Application Laid-open No. 2006-115435 (Patent Literature 1) describes a technology of “connecting monitoring cameras installed respectively at a plurality of monitoring points, and personal computers installed near the monitoring points or in a monitoring facility to each other in a wired or wireless manner, connecting the personal computers and communication terminal devices including displays, such as personal computers at a remote site, to each other via the Internet, and causing images captured at the monitoring points, and images of press buttons for allowing selection and control of the monitoring cameras to be displayed on the displays of the communication terminal devices.”

### PRIOR-ART LITERATURE

### Patent Literature

Patent Literature 1: Japanese Patent Application Laid-open No. 2006-115435

### SUMMARY OF INVENTION

### Technical Problem

In the technology described in Patent Literature 1, videos captured by the cameras are transmitted to the communication terminal devices via the personal computers. Thus, the technology described in Patent Literature 1 has a disadvantage in that volume of communication is increased, which results in increasing cost necessary for the communication. Further, there is another disadvantage in that the administrator must engage, for a longer time period, in checking the videos displayed on the communication terminal devices.

The present invention, which has been made in view of such circumstances, has an object of providing a video monitoring method, a server, and a video monitoring system that are capable of reducing volume of communication necessary for video monitoring, and a burden on an administrator during the video monitoring.

### Solution to Problem

According to the present invention, there is provided a video monitoring method,

in which a camera captures and records a moving image,

in which the camera transmits, to a server, still images extracted at first time intervals from the moving image,

in which the server transmits the still images to an administrator terminal,

in which the administrator terminal accepts input for designating the still image,

in which the server transmits an information item for specifying the designated still image to the camera,

in which the camera transmits, to the server, the moving image recorded by the camera and having a predetermined duration preceding and including the designated still image, or a plurality of a still images extracted at second time intervals each shorter than the predetermined duration from the moving image recorded by the camera and having a predetermined duration preceding and including the designated still image, and

in which the server transmits, to the administrator terminal, the moving image recorded by the camera and having a predetermined duration preceding and including the designated still image, or the plurality of a still images extracted at the second time intervals.

With this configuration, volume of communication necessary for video monitoring can be reduced, and in addition, a burden on an administrator during the video monitoring can be reduced.

It is preferred that, in the video monitoring method according to the present invention, the still images that the server transmits to the administrator terminal be thumbnail images.

With this configuration, the still images can be listed on the administrator terminal side, and the burden on the administrator during the video monitoring can be further reduced.

According to the present invention, there is provided a server including a communication unit configured to receive still images extracted at first time intervals from a moving image recorded by a camera, and to transmit, to the camera, an information item for specifying the still image that is designated via an administrator terminal,

the communication unit
receiving, from the camera, the moving image having a predetermined duration preceding and including the designated still image, or a plurality of a still images extracted at second time intervals each shorter than the predetermined duration from the moving image recorded by the camera and having a predetermined duration preceding and including the designated still image, and
transmitting, to the administrator terminal, the received moving image or the plurality of a still images extracted at the second time intervals.

According to the present invention, there is provided a video monitoring system including:

a camera; and

a server that is connected to the camera via a network,

the camera being configured to capture and record a moving image, and to transmit, to the server, still images extracted at first time intervals from the moving image,

the server including a communication unit
configured to receive the still images extracted at the first time intervals from the moving image recorded by the camera, and
configured to transmit, to the camera, an information item for specifying the still image that is designated via an administrator terminal,

the communication unit
receiving, from the camera, the moving image having a predetermined duration preceding and including the designated still image, or a plurality of a still images extracted at second time intervals each shorter than the predetermined duration from the moving image recorded by the camera and having a predetermined duration preceding and including the designated still image, and
transmitting, to the administrator terminal, the moving image recorded by the camera and having a predetermined duration preceding and including the designated still image or the plurality of a still images extracted at the second time intervals.

According to the present invention, there is provided another video monitoring method,

in which a camera captures and records a moving image,

in which the camera transmits, to a server, still images extracted at first time intervals from the moving image,

in which the server transmits, to an administrator terminal, the still images received from the camera,

in which the administrator terminal accepts input for designating the still image,

in which the server transmits an information item for specifying the designated still image to the camera,

in which the camera detects a difference between the still image at a start of a predetermined duration preceding and including the designated still image, and the designated still image, and

in which the camera searches the moving image having the predetermined duration preceding and including the designated still image, specifies the still images between which the difference is generated, and transmits a moving image containing the specified still images to the server.

With this configuration, the burden on the administrator during the video monitoring can be further reduced.

It is preferred that, in the another video monitoring method according to the present invention, the camera detect the difference from a predetermined region in the still images.

With this configuration, for example, a case where a vehicle is properly parked in a parking lot can be restrained from being erroneously detected as an event.

It is preferred that, in the another video monitoring method according to the present invention, the administrator terminal reproduce the moving image containing the still images between which the difference is detected.

With this configuration, the erroneous detection of the event can be restrained, and the burden on the administrator during the video monitoring can be further reduced.

### Advantageous Effects of Invention

According to the present invention, not only volume of communication necessary for video monitoring, but also a burden on an administrator during the video monitoring can be reduced.

### BRIEF DESCRIPTION OF DRAWINGS

FIG. 1 A configuration diagram of a video monitoring system according to a first embodiment of the present invention.

FIG. 2A A schematic view of an administrator screen displayed on a display of an administrator terminal in the video monitoring system according to the first embodiment of the present invention, specifically, illustrating an example of a case where one of thumbnail images before occurrence of an event is designated.

FIG. 2B Another schematic view of the administrator screen displayed on the display of the administrator terminal in the video monitoring system according to the first embodiment of the present invention, specifically, illustrating an example of a case where another of the thumbnail images after the occurrence of the event is designated.

FIG. 2C Still another schematic view of the administrator screen displayed on the display of the administrator terminal 300 of the first embodiment of the present invention.

FIG. 3A An explanatory flowchart showing an operation of the video monitoring system according to the first embodiment, the system being shown in FIG. 1.

FIG. 3B An explanatory flowchart that is subsequent to FIG. 3A and shows the operation of the video monitoring system according to the first embodiment, the system being shown in FIG. 1.

FIG. 3C An explanatory flowchart showing a modification of the embodiment of the present invention.

FIG. 4A An explanatory flowchart showing an operation of a video monitoring system according to a second embodiment.

FIG. 4B An explanatory flowchart that is subsequent to FIG. 4A and shows the operation of the video monitoring system according to the second embodiment.

### DESCRIPTION OF EMBODIMENTS

### First Embodiment

[Overall Configuration]

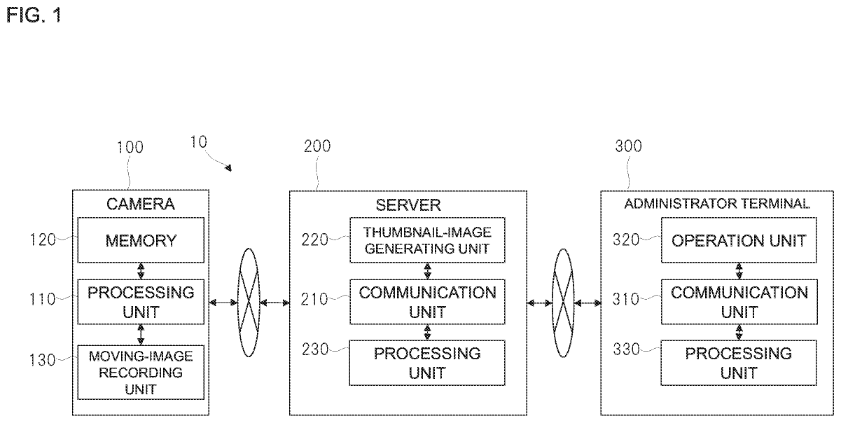

Below, a first embodiment of the present invention is described. FIG. 1 is a diagram showing an example of a video monitoring system 10 according to a first embodiment of the present invention. The video monitoring system 10 shown in FIG. 1 includes a camera 100, a server 200 connected to the camera 100 via a network, and an administrator terminal 300 connected to the server 200 via a network.

The camera 100 has a function to capture a moving image. Further, the camera 100 includes a processing unit 110, a memory 120, and a moving-image recording unit 130.

The processing unit 110 of the camera 100 stores the captured moving image to the memory 120. Further, the processing unit 110 acquires the moving image stored in the memory 120, and extracts still images from the acquired moving image at first time intervals (for example, 60 minutes). Then, the camera 100 transmits the still images extracted at the first time intervals to the server 200. In this way, the still images extracted from the captured moving image are transmitted, and hence communication volume can be reduced in comparison with a case of transmitting an entirety of the moving image. Further, particularly when the administrator terminal 300 is charged based on the number of packets, increase in communication cost can be restrained.

Further, the processing unit 110 of the camera 100 extracts, from the moving image that has already been stored in the memory 120, a moving image having a predetermined duration preceding and including a still image specified based on a still-image-specifying information item (information item for specifying a still image designated via an operation unit 320 of the administrator terminal 300). For example, the processing unit 110 of the camera 100 extracts, from the moving image that has already been stored, a moving image of from a still image at a start of the predetermined duration preceding and including the still image specified based on the still-image-specifying information item (such as an identifier for identifying the still image, a file name of the still image, and a time when the still image is captured) to the still image specified based on the still-image-specifying information item. In addition, the processing unit 110 of the camera 100 extracts, from the extracted moving image, still images at second time intervals (for example, 5 minutes) each shorter than the predetermined duration (a length of the extracted moving image).

The camera 100 transmits, to the server, the moving image having the predetermined duration preceding and including the designated still image, or the plurality of still images extracted at the second time intervals each shorter than the predetermined duration from the moving image having the predetermined duration. With this, the volume of the communication necessary for video monitoring can be reduced, and in addition, a burden on an administrator during the video monitoring can be reduced.

The server 200 includes a communication unit 210, a thumbnail-image generating unit 220, and a processing unit 230 that performs, for example, input and output of data items necessary for controlling the units of the server 200.

The communication unit 210 of the server 200 receives the still images, the moving image, and various information items transmitted from the camera 100 and the administrator terminal 300. Further, the communication unit 210 transmits thumbnail images, the moving image, and the various information items to the camera 100 and the administrator terminal 300. For example, the communication unit 210 transmits the moving image having the predetermined duration, or the plurality of still images extracted at the second time intervals to the administrator terminal 300. Further, the communication unit 210 receives the still images extracted at the first time intervals from the moving image recorded by the camera 100, and transmits the information item for specifying the still image designated via the administrator terminal 300 to the camera 100. In addition, the communication unit 210 receives the moving image having the predetermined duration preceding and including the designated still image, or the plurality of still images extracted at the second time intervals each shorter than the predetermined duration from the moving image having the predetermined duration, and transmits the received moving image or the plurality of still images extracted at the second time intervals to the administrator terminal 300.

The thumbnail-image generating unit 220 of the server 200 generates the thumbnail images based on the still images input thereto. With this, the still images can be listed on the administrator terminal 300 side, and the burden on the administrator during the video monitoring can be further reduced.

The administrator terminal (such as a smartphone, a feature phone, and a tablet terminal) 300 includes a communication unit 310, and the operation unit 320, and a processing unit 330. The administrator terminal 300 includes a display that displays the still images. By monitoring the still images displayed on the display, the administrator checks occurrence of an event (such as littering).

The operation unit 320 of the administrator terminal 300 accepts input for designating the still image.

The communication unit 310 of the administrator terminal 300 receives the still images and the moving image transmitted from the server 200. Further, the communication unit 310 transmits the still-image-specifying information item being the information item for specifying the still image designated via the operation unit 320 to the camera 100.

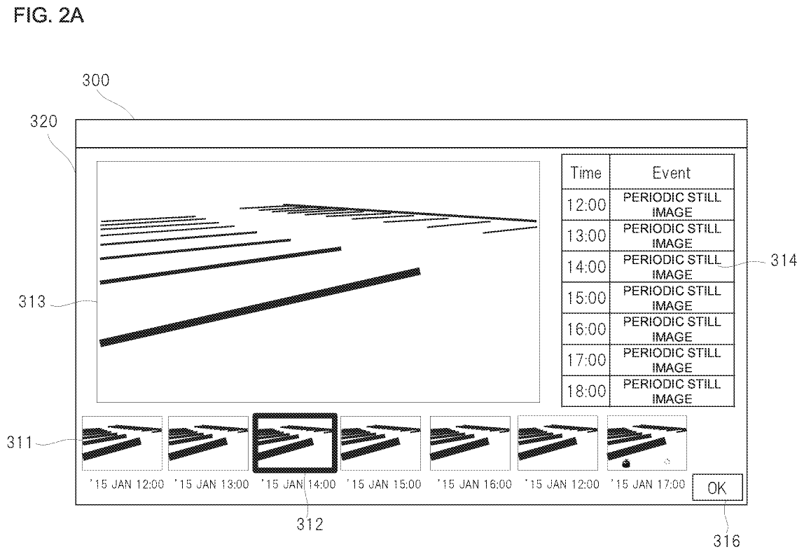

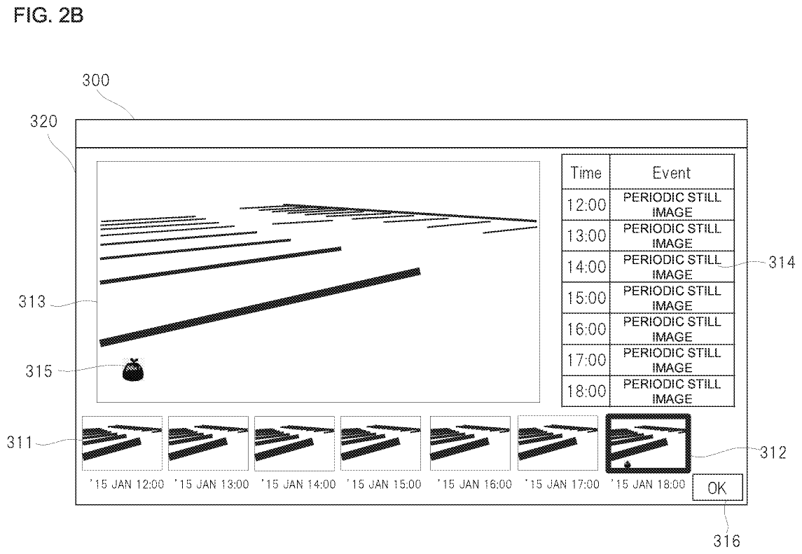

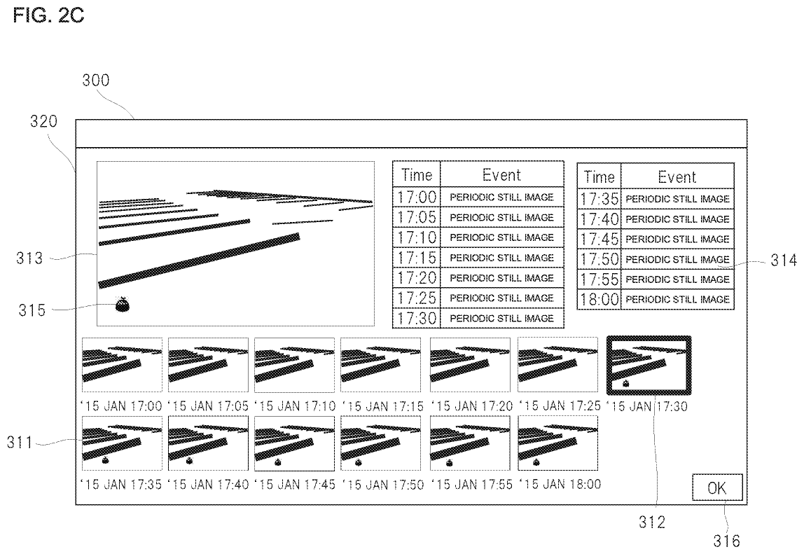

The processing unit 330 of the administrator terminal 300 causes the administrator screen (described above, FIG. 2), which depicts the thumbnail images transmitted from the server 200, to be displayed on the display.

[Administrator Screen]

FIG. 2A is a schematic view of the administrator screen displayed on the display of the administrator terminal 300 of the first embodiment of the present invention, specifically, illustrating an example of a case where one of thumbnail images 311 before the occurrence of the event is designated.

FIG. 2B is another schematic view of the administrator screen displayed on the display of the administrator terminal 300 in the video monitoring system according to the first embodiment of the present invention, specifically, illustrating an example of a case where another of the thumbnail images 311 after the occurrence of the event is designated.

The display of the administrator terminal 300 displays the screen, and functions as the operation unit 320 that accepts a touch operation by the user via a touchscreen. More specifically, the operation unit 320 detects a touch operation to a screen display region. In addition, the operation unit 320 executes a process corresponding to a position at which the touch operation is accepted.

As illustrated in FIG. 2A and FIG. 2B, on the display of the administrator terminal 300, the plurality of thumbnail images 311 are listed in a right-and-left direction. Further, times when the thumbnail images 311 are captured and types of the thumbnail images (or details of the event having occurred) are listed in correlation with each other in a time display field 314.

The operation unit 320 accepts the input for designating any of the listed thumbnail images 311. A frame of the designated thumbnail image 311 is highlighted by a marker 312. Further, an enlarged image of the designated thumbnail image 311 is displayed in an enlarged-image display region 313.

When a thumbnail image 311 in which, for example, a piece of litter 315 is left is designated, as illustrated in FIG. 2B, the image depicting the piece of litter 315 having been left is displayed in the enlarged-image display region 313.

Under a state in which the thumbnail image (such as a thumbnail image immediately after the occurrence of the event) 311 is designated, when an OK button 316 is touched, the communication unit 310 of the administrator terminal 300 transmits the still-image-specifying information item for specifying the designated thumbnail image (still image) 311 to the server 200. Note that, a time may be entered into an input field (not shown), and the entered time the still-image-specifying information item may be transmitted to the server 200.

FIG. 2C is still another schematic view of the administrator screen displayed on the display of the administrator terminal 300 of the first embodiment of the present invention, specifically, illustrating an example of the case where the still images extracted at the second time intervals (5 minutes) are listed.

As illustrated in FIG. 2C, on the display of the administrator terminal 300, the plurality of (thirteen) thumbnail images 311 extracted at the intervals of the five minutes within a predetermined time zone (17:00 to 18:00) are listed in matrix and in correlation with the capture times.

[Entire Process]

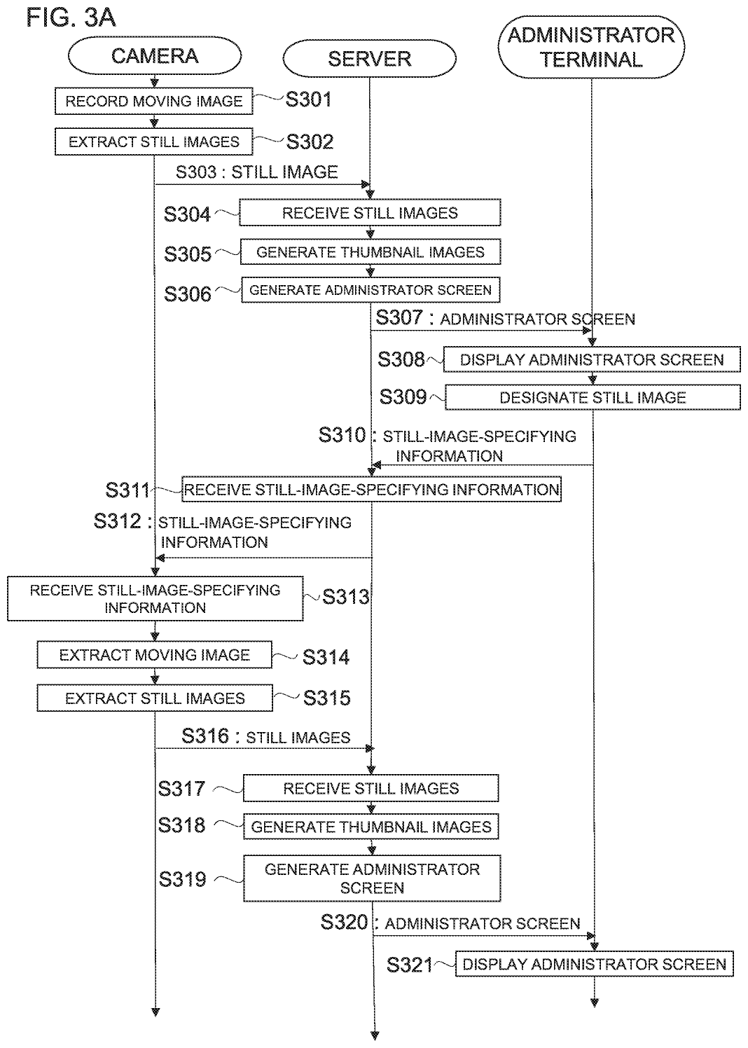

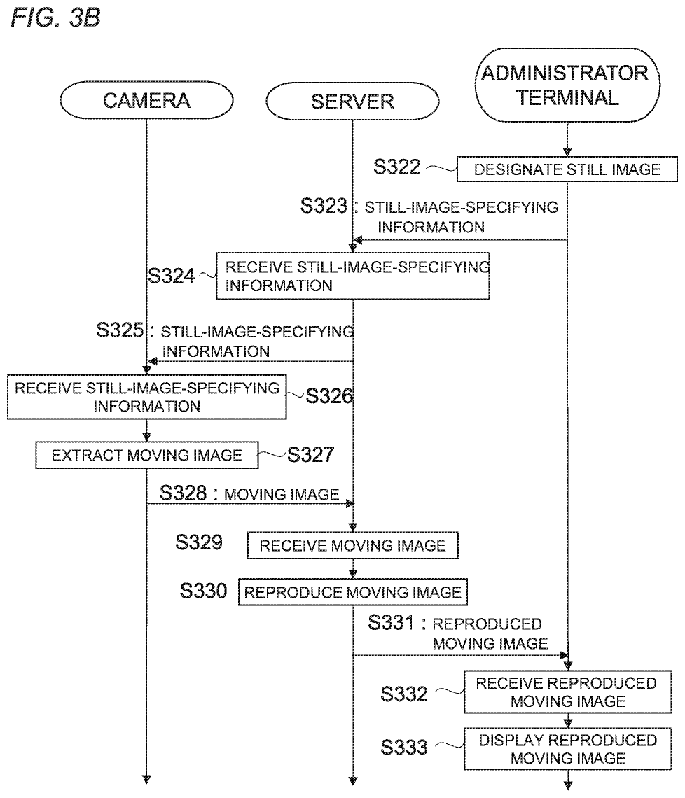

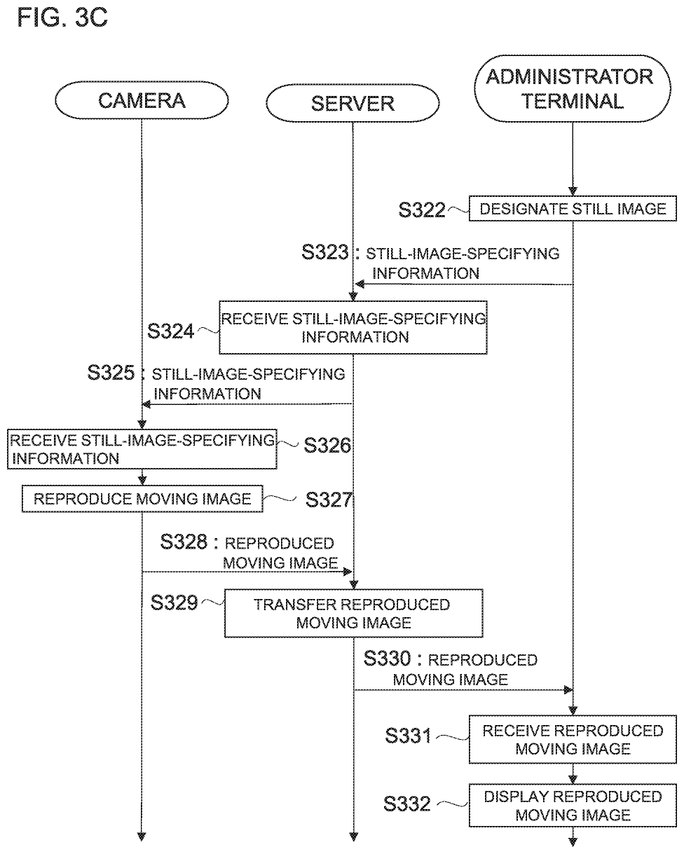

FIG. 3A and FIG. 3B are schematic flowcharts showing an entire process of the first embodiment of the present invention. FIG. 3B is subsequent to FIG. 3A.

First, the camera 100 captures a moving image. Further, the processing unit 110 of the camera 100 records the captured moving image into the memory 120 (S301).

Then, the processing unit 110 of the camera 100 extracts still images at the first time intervals (for example, 1 hour) from the moving image recorded in the memory 120 (S302).

Next, the camera 100 transmits the extracted still images to the server 200 (S303).

After that, the communication unit 210 of the server 200 receives the still images transmitted from the camera 100 (S304). Further, the communication unit 210 inputs the received still images to the thumbnail-image generating unit 220.

Then, the thumbnail-image generating unit 220 of the server 200 generates thumbnail images based on the input still images (S305). The thumbnail-image generating unit 220 inputs the generated thumbnail images to the communication unit 210.

Next, the server 200 generates an administrator screen (described above, FIG. 2) that depicts the thumbnail images generated in S305 (S306).

After that, the communication unit 210 of the server 200 transmits the administrator screen generated in S306 (screen data item for displaying the administrator screen) to the administrator terminal 300 (S307).

Then, the processing unit 330 of the administrator terminal 300 causes the administrator screen (described above, FIG. 2), which depicts the thumbnail images, to be displayed on the display (S308).

Next, the operation unit 320 of the administrator terminal 300 accepts input for designating a still image (S309).

After that, the communication unit 310 of the administrator terminal 300 transmits a still-image-specifying information item being the information item for specifying the still image designated in S309 to the server 200 (S310).

Then, the communication unit 210 of the server 200 receives the still-image-specifying information item transmitted from the administrator terminal 300 (S311).

Next, the communication unit 210 of the server 200 transmits the still-image-specifying information item to the camera 100 (S312).

After that, the camera 100 receives the still-image-specifying information item (S313).

Then, the processing unit 110 of the camera 100 extracts, from the moving image that has already been stored, a moving image having a predetermined duration preceding and including the still image specified based on the still-image-specifying information item (S314).

Next, the processing unit 110 of the camera 100 extracts still images at the second time intervals (for example, 5 minutes) from the moving image extracted in S314 (S315).

After that, the camera 100 transmits the plurality of extracted still images to the server 200 (S316).

Then, the communication unit 210 of the server 200 receives the plurality of still images transmitted from the camera 100 (S317). The communication unit 210 inputs the plurality of received still images to the thumbnail-image generating unit 220.

Next, the thumbnail-image generating unit 220 of the server 200 generates a plurality of thumbnail images based on the plurality of input still images (S318). The thumbnail-image generating unit 220 inputs the plurality of generated thumbnail images to the communication unit 210.

After that, the communication unit 210 of the server 200 generates an administrator screen (described above, FIG. 2) that depicts the thumbnail images generated in S318 (S319).

Then, the server 200 transmits the administrator screen generated in S319 (screen data item for displaying the administrator screen) to the administrator terminal 300 (S320).

Next, the processing unit 330 of the administrator terminal 300 causes the administrator screen (described above, FIG. 2), which depicts the plurality of thumbnail images, to be displayed on the display (S321).

After that, the operation unit 320 of the administrator terminal 300 accepts input for designating a still image (S322).

Then, the communication unit 310 of the administrator terminal 300 transmits a still-image-specifying information item being the information item for specifying the still image designated in S322 to the server 200 (S323).

Next, the communication unit 210 of the server 200 receives the still-image-specifying information item transmitted from the administrator terminal 300 (S324).

After that, the communication unit 210 of the server 200 transmits the still-image-specifying information item to the camera 100 (S325).

Then, the camera 100 receives the still-image-specifying information item (S326).

Next, the processing unit 110 of the camera 100 extracts, from the moving image that has already been stored, a moving image having a predetermined duration (for example, 5 minutes) preceding and including the still image specified based on the still-image-specifying information item (S327).

After that, the processing unit 110 of the camera 100 transmits the moving image extracted in S327 to the server 200 (S328).

Then, the communication unit 210 of the server 200 receives the moving image transmitted from the camera 100 (S329).

Next, the server 200 reproduces the moving image (S330). For example, the server 200 performs streaming reproduction of the moving image.

After that, the communication unit 210 of the server 200 transmits the reproduced moving image being reproduced in S330 to the administrator terminal 300 (S331).

Then, the communication unit 310 of the administrator terminal 300 receives the reproduced moving image transmitted from the server 200 (S332).

Next, the processing unit 330 of the administrator terminal 300 causes the received reproduced moving image to be displayed on the display (S333).

Note that, without the generation of the thumbnail images in S305 and S318, the communication unit 310 of the server 200 may transmit the still images to the administrator terminal 300 in S306 and S319.

Further, instead of transmitting the extracted still images to the server 200, the camera 100 may transmit thereto, in S316, the moving image having the predetermined duration preceding and including the designated still image.

In addition, as shown in FIG. 3C, the camera 100 may reproduce the moving image in S327, the server 200 may transfer the reproduced moving image in S329, and the administrator terminal 300 may display the reproduced moving image in S332.

### Second Embodiment

A second embodiment is different from the first embodiment in that, in the first embodiment, the still image depicting occurrence of an event is specified on the administrator terminal 300 side, but in the second embodiment, the still image depicting the occurrence of the event is specified on the camera 100 side. More specifically, the processing unit 110 of the camera 100 of the second embodiment is different from that of the first embodiment in detecting a difference between the still image at the start of the predetermined duration preceding and including the designated still image (still image specified based on the still-image-specifying information item), and the designated still image. In addition, the processing unit 110 of the camera 100 of the second embodiment is different from that of the first embodiment in searching the moving image having the predetermined duration preceding and including the designated still image, specifying still images between which the difference is generated, and transmitting a moving image containing the specified still images to the server 200. With this, the burden on the administrator during the monitoring, and the volume of the communication can be further reduced. Note that, the still image depicting the occurrence of the event may be specified by the server 200.

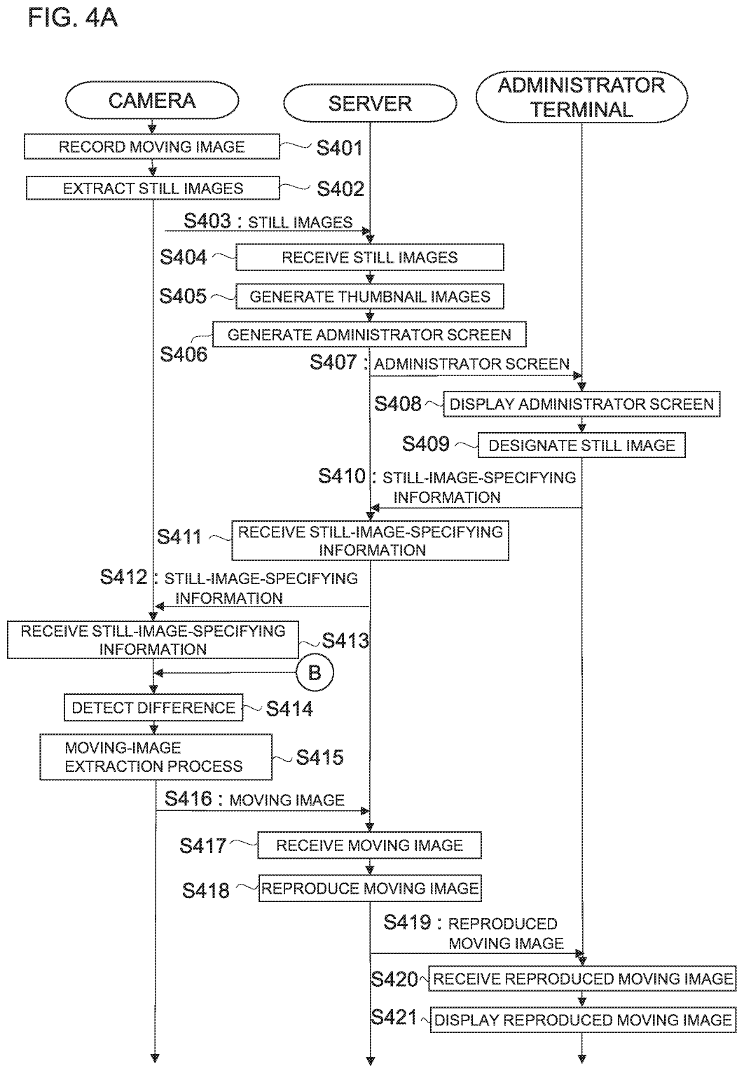

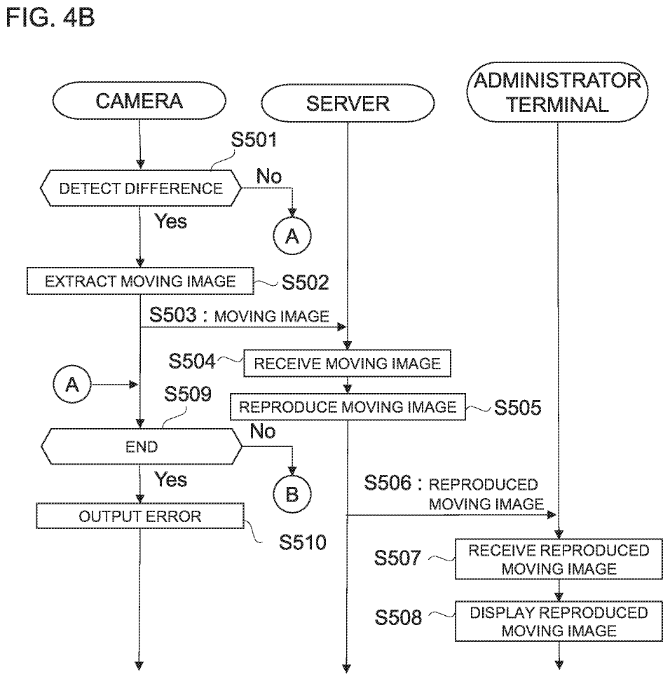

Below, with a focus on the difference from the first embodiment, the second embodiment is described with reference to FIG. 4A and FIG. 4B.

[Entire Process]

FIG. 4A and FIG. 4B are schematic flowcharts showing an entire process of the second embodiment of the present invention.

First, the camera 100 captures a moving image. Further, the processing unit 110 of the camera 100 records the captured moving image into the memory 120 (S401).

Then, the processing unit 110 of the camera 100 extracts still images at the first time intervals (for example, 1 hour) from the moving image recorded in the memory 120 (S402).

Next, the camera 100 transmits the extracted still images to the server 200 (S403).

After that, the communication unit 210 of the server 200 receives the still images transmitted from the camera 100 (S404). The communication unit 210 inputs the received still images to the thumbnail-image generating unit 220.

Then, the thumbnail-image generating unit 220 of the server 200 generates thumbnail images based on the input still images (S405). The thumbnail-image generating unit 220 inputs the generated thumbnail images to the communication unit 210.

Next, the server 200 generates an administrator screen that depicts the thumbnail images generated in S405 (S406).

After that, the communication unit 310 of the administrator terminal 300 transmits the administrator screen generated in S406 (image data item for displaying the administrator screen) to the administrator terminal 300 (S407).

Then, the processing unit 330 of the administrator terminal 300 causes the administrator screen (described above, FIG. 2), which depicts the received thumbnail images, to be displayed on the display (S408).

Next, the operation unit 320 of the administrator terminal 300 accepts input for designating a still image (S409).

After that, the communication unit 310 of the administrator terminal 300 transmits a still-image-specifying information item being the information item for specifying the still image designated in S409 to the server 200 (S410).

Then, the communication unit 210 of the server 200 receives the still-image-specifying information item transmitted from the administrator terminal 300 (S411).

Next, the communication unit 210 of the server 200 transmits the still-image-specifying information item to the camera 100 (S412).

After that, the camera 100 receives the still-image-specifying information item (S413).

Then, the processing unit 110 of the camera 100 detects a difference between a still image at a start of a predetermined duration preceding and including the still image specified based on the still-image-specifying information item, and the still image specified based on the still-image-specifying information item (S414).

Next, the processing unit 110 of the camera 100 executes a moving-image extraction process (described below, FIG. 4B) (S415). With this, the processing unit 110 of the camera 100 specifies still images between which the difference is generated.

After that, the camera 100 transmits a moving image containing the still images specified in S415 to the server 200 (S416). Note that, when the difference is not detected in S414, the camera 100 does not transmit the moving image to the server 200.

Then, the communication unit 210 of the server 200 receives the moving image transmitted from the camera 100 (S417).

Next, the server 200 reproduces the moving image (S418).

After that, the communication unit 210 of the server 200 transmits the reproduced moving image being reproduced in S418 to the administrator terminal 300 (S419).

Then, the communication unit 310 of the administrator terminal 300 receives the reproduced moving image transmitted from the server 200 (S420).

Next, the processing unit 330 of the administrator terminal 300 causes the received reproduced moving image to be displayed on the display (S421).

Note that, in S414, the camera 100 may detect the difference from a predetermined region in the still images (for example, after accepting input for designating the region). With this, a case where a vehicle is properly parked in a parking lot, or a case where the vehicle moves in the parking lot can be restrained from being erroneously detected as an event. Note that, as an example of the region for detecting the difference, there is given a region in the parking lot in which a piece of litter has ever been left. Further, as another example of the region for detecting the difference, there is given a region out of a parking space or of a region in which the vehicle travels. In addition, as still other examples of the region for detecting the difference, there are given an entrance of a building, a region where natural disasters frequently occur, and a dump.

Further, in S421, the administrator terminal 300 may display the moving image containing the still images between which the difference is detected. With this, the erroneous detection of the event can be restrained, and the burden on the administrator during the video monitoring can be reduced. In other words, by omitting the communication and the reproduction of the moving image except the case where the event has occurred, the volume of the communication, and the burden of the video monitoring can be further reduced.

[Moving-Image Extraction Process]

FIG. 5 is a schematic flowchart showing the moving-image extraction process of the second embodiment of the present invention.

First, the camera 100 determines whether or not the difference has been detected in S414 (S501).

When determining, in S501, that the difference has been detected, the camera 100 extracts the moving image (S502). Then, the camera 100 transmits the extracted moving image to the server 200 (S503).

Then, the server 200 receives the moving image (S504).

Next, the server 200 reproduces the moving image (S505).

After that, the communication unit 200 of the server 200 transmits the reproduced moving image being reproduced in S505 to the administrator terminal 300 (S506).

Then, the administrator terminal 300 receives the reproduced moving image (S507). Next, the administrator terminal 300 causes the received reproduced moving image to be displayed on the display (S508).

When determining, in S501, that the difference has not been detected, the camera 100 determines whether to end the detection of the difference (S509). When determining to end the detection of the difference, the camera 100 outputs an error (S510). Meanwhile, when the camera 100 determines not to end the detection of the difference, the flow returns to S414.

The present invention is not limited to the above-described embodiments.

Specifically, those skilled in the art may make various modifications, combinations, sub-combinations, and alterations of the components of the above-described embodiments within the technical scope of the present invention or the equivalents thereof. For example, the above-described embodiments need not necessarily be limited to embodiments including all the above-described components. Further, the configuration of one of the embodiments may be partially replaced with the configuration of another of the embodiments. In addition, the configuration of the other of the embodiments may be added to the configuration of the one of the embodiments.

Further, the control lines and the information lines in the illustration are ones that are presumably necessary for the description, and hence not all control lines and information lines of a product are shown.

### INDUSTRIAL APPLICABILITY

The present invention is applicable to a monitoring system that uses the moving image and the still images captured by the camera 100 and displayed on the display of, for example, the administrator terminal 300.

### REFERENCE SIGNS LIST

10 . . . video monitoring system
100 . . . camera
110 . . . processing unit
120 . . . memory
200 . . . server
210 . . . communication unit
220 . . . thumbnail-image generating unit
230 . . . processing unit
300 . . . administrator terminal
310 . . . communication unit
320 . . . operation unit
330 . . . processing unit

1-7. (canceled)

8. A video monitoring method, comprising:
a camera capturing and recording a moving image,
the camera transmitting, to a server, still images extracted at first time intervals from the moving image,
the server transmitting the still images to an administrator terminal,
the administrator terminal accepting input for designating the still image,
the server transmitting an information item for specifying the designated still image to the camera,
the camera transmitting, to the server, the moving image recorded by the camera and having a predetermined duration preceding and including the designated still image, or a plurality of a still images extracted at second time intervals each shorter than the predetermined duration from the moving image recorded by the camera and having a predetermined duration preceding and including the designated still image, and
the server transmitting, to the administrator terminal, the moving image recorded by the camera and having a predetermined duration preceding and including the designated still image, or the plurality of a still images extracted at the second time intervals.

9. The video monitoring method according to claim 8, wherein the still images that the server transmits to the administrator terminal are thumbnail images.

10. A server comprising:
a communication unit configured to receive still images extracted at first time intervals from a moving image recorded by a camera, and to transmit, to the camera, an information item for specifying the still image that is designated via an administrator terminal,
the communication unit
receives, from the camera, the moving image having a predetermined duration preceding and including the designated still image, or a plurality of a still images extracted at second time intervals each shorter than the predetermined duration from the moving image recorded by the camera and having a predetermined duration preceding and including the designated still image, and
transmits, to the administrator terminal, the received moving image or the plurality of a still images extracted at the second time intervals.

11. A video monitoring system comprising:
a camera; and
a server that is connected to the camera via a network,
the camera being configured to capture and record a moving image, and to transmit, to the server, still images extracted at first time intervals from the moving image,
the server including a communication unit
configured to receive the still images extracted at the first time intervals from the moving image recorded by the camera, and
configured to transmit, to the camera, an information item for specifying the still image that is designated via an administrator terminal,
the communication unit
receives, from the camera, the moving image having a predetermined duration preceding and including the designated still image, or a plurality of the still images extracted at second time intervals each shorter than the predetermined duration from the moving image recorded by the camera and having a predetermined duration preceding and including the designated still image, and
transmits, to the administrator terminal, the received moving image or the plurality of a still images extracted at the second time intervals.

12. A video monitoring method,
a camera capturing and recording a moving image,
the camera transmitting, to a server, still images extracted at first time intervals from the moving image,
the server transmitting, to an administrator terminal, the still images received from the camera,
the administrator terminal accepting input for designating the still image,
the server transmitting an information item for specifying the designated still image to the camera,
the camera detecting a difference between the still image at a start of a predetermined duration preceding and including the designated still image, and the designated still image, and
the camera searching the moving image having the predetermined duration preceding and including the designated still image, specifies the still images between which the difference is generated, and transmits a moving image containing the specified still images to the server.

13. The video monitoring method according to claim 12, wherein the camera detects the difference from a predetermined region in the still images.

14. The video monitoring method according to claim 13, wherein the administrator terminal reproduces the moving image containing the still images between which the difference is detected.
